(19) United States
(12) Patent Application Publication
(10) Pub. No.: US 2025/0274823 A1
(43) Pub. Date: Aug. 28, 2025

(54) METHOD FOR INDICATING TIMING ADVANCES AND DEVICE

(71) Applicant: GUANGDONG OPPO MOBILE TELECOMMUNICATIONS CORP., LTD., Dongguan (CN)

(72) Inventors: Xin YOU, Dongguan (CN); Xue LIN, Dongguan (CN)

(21) Appl. No.: 19/191,829

(22) Filed: Apr. 28, 2025

Related U.S. Application Data
(63) Continuation of application No. PCT/CN2022/129654, filed on Nov. 3, 2022.

(51) Int. Cl. H04W 36/00; H04W 36/08

(52) U.S. Cl. CPC H04W 36/0072; H04W 36/08

(57) ABSTRACT

Provided is a method for indicating timing advances. The method is applicable to a terminal device and the method includes: receiving first indication information, wherein the first indication information indicates information of a timing advance (TA) for a first cell, the first cell comprising at least one of a candidate cell for cell handover or a target cell for cell handover.

### CROSS-REFERENCE TO RELATED APPLICATION

This application is a continuation of International Application No. PCT/CN2022/129654, filed Nov. 3, 2022, the entire disclosure of which is incorporated herein by reference.

### TECHNICAL FIELD

The present disclosure relates to the field of wireless communication technology, and in particular, relates to a method for indicating timing advances, and a device thereof.

### RELATED ART

In a wireless communication system, when a terminal device moves from one cell to another, a handover of the serving cell is required to maintain uninterrupted communication of the mobile terminal.

### SUMMARY

Embodiments of the present disclosure provide a method for indicating timing advances, and a device thereof. The technical solution is as follows.

Some embodiments of the present disclosure provide a method for indicating timing advances. The method is applicable to a terminal device, and the method includes: receiving first indication information, wherein the first indication information indicates information of a timing advance (TA) for a first cell, the first cell including at least one of a candidate cell for cell handover or a target cell for cell handover.

Some embodiments of the present disclosure provide a terminal device. The terminal device includes a processor and a memory. The memory stores a computer program, and the processor is configured to load and run the computer program, to cause the terminal device to: receive first indication information, wherein the first indication information indicates information of a TA for a first cell, the first cell including at least one of a candidate cell for cell handover or a target cell for cell handover.

Some embodiments of the present disclosure provide a network device. The network device includes a processor and a memory. The memory stores a computer program, and the processor is configured to load and run the computer program, to cause the network device to: transmit first indication information to a terminal device, wherein the first indication information indicates information of a TA for a first cell, the first cell including at least one of a candidate cell for cell handover or a target cell for cell handover.

### BRIEF DESCRIPTION OF DRAWINGS

For clearer description of the technical solutions according to the embodiments of the present disclosure, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic diagram of an architecture of a communication system involved in some embodiments of the present disclosure;

FIG. 2 is a differential adjustment format of a TA of a medium access control (MAC) control element (CE) involved in the present disclosure;

FIG. 3 is a format diagram of an absolute MAC CE involved in the present disclosure;

FIG. 4 is a format diagram of a MAC random access response (RAR) involved in the present disclosure;

FIG. 5 is a flowchart of a method for indicating timing advances according to some embodiments of the present disclosure;

FIG. 6 is a flowchart of a method for indicating timing advances according to some embodiments of the present disclosure;

FIG. 7 is a flowchart of a method for indicating timing advances according to some embodiments of the present disclosure;

FIG. 8 is a block diagram of an apparatus for indicating timing advances according to some embodiments of the present disclosure;

FIG. 9 is a block diagram of an apparatus for indicating timing advances according to some embodiments of the present disclosure; and

FIG. 10 is a schematic structural diagram of a device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

The network architecture and service scenarios described in the embodiments of the present disclosure are to more clearly illustrate the technical solutions of the embodiments of the present disclosure and do not constitute a limitation on the technical solutions provided by the embodiments of the present disclosure. Those skilled in the art would know that with the evolution of network architecture and the emergence of new service scenarios, the technical solutions provided by the embodiments of the present disclosure are also applicable to similar technical problems.

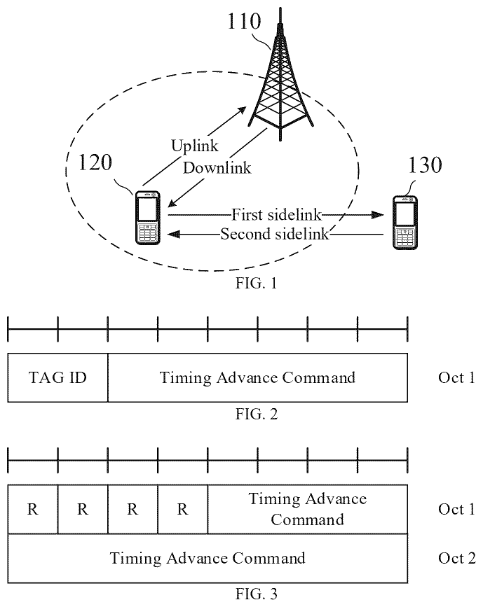

FIG. 1 illustrates a schematic diagram of a communication system involved in some embodiments of the present disclosure. The communication system includes a network device 110 and a terminal device 120, and/or the terminal device 120 and a terminal device 130, which are not limited in the present disclosure.

The network device 110 in the present disclosure provides wireless communication functions. The network device includes but not limited to: an evolved node B (eNB), a radio network controller (RNC), a node B (NB), a base station controller (BSC), a base transceiver station (BTS), a home base station (e.g., a home evolved node B, or a home node B, HNB), a baseband unit (BBU), an access point (AP) in a wireless fidelity (Wi-Fi) system, a wireless relay node, a wireless backhaul node, a transmission point (TP) or a transmission and reception point (TRP), or the like. It may also be a next generation node B (gNB) or a transmission point (a TRP or a TP) in a 5th generation (5G) mobile communication system, or one or a set of antenna panels (including a plurality of antenna panels) of a base station in the 5G system, or a network node constituting a gNB or a transmission point, such as a baseband unit (BBU) or a distributed unit (DU), or the like, or a base station in a beyond 5th generation (B5G), a 6th generation (6G) mobile communication system, or the like, or a core network (CN), a fronthaul, a backhaul, a radio access network (RAN), a network slice, or the like, or a serving cell, a primary cell (PCell), a primary secondary cell (PSCell), a special Cell (SpCell), a secondary cell (SCell), a neighboring cell, or the like, of the terminal device.

The terminal device 120 and/or terminal device 130 in the present disclosure, also known as a user equipment (UE), an access terminal, a user unit, a user station, a mobile station, a mobile terminal, a remote station, a remote terminal, a mobile device, a user terminal, a terminal, a wireless communication device, a user agent, a user device. The terminal includes but is not limited to: a handheld device, a wearable device, an in-vehicle device, an Internet of things device, or the like, such as: a mobile phone, a tablet, an e-book reader, a laptop, a desktop computer, a television, a game console, a mobile Internet device (MID), an augmented reality (AR) terminal, a virtual reality (VR) terminal, and a mixed reality (MR) terminal, a wearable device, a handle, an electronic tag, a controller, a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, a wireless terminal in remote medical surgery, a cellular phone, a cordless phone, a Session Initiation Protocol (SIP) phone, a wireless local loop (WLL) station, a personal digital assistant (PDA), a set top box (STB), a customer premise equipment (CPE), or the like.

The network device 110 and the terminal device 120 communicate with each other using an air interface technology, such as a Uu interface.

In some embodiments, there are two communication scenarios between the network device 110 and the terminal device 120: an uplink communication scenario and a downlink communication scenario. The uplink communication refers to transmitting signals to the network device 110; and the downlink communication refers to transmitting signals to the terminal device 120.

The terminal device 120 and the terminal device 130 communicate with each other using an air interface technology, such as a Uu interface.

In some embodiments, there are two communication scenarios between the terminal device 120 and the terminal device 130: a first sidelink communication scenario and a second sidelink communication scenario. The first sidelink communication refers to transmitting signals to the terminal device 130; and the second sidelink communication refers to transmitting signals to the terminal device 120.

Both the terminal device 120 and the terminal device 130 are within a network coverage and located in the same cell, or both the terminal device 120 and the terminal device 130 are within the network coverage but located in different cells, or the terminal device 120 is within the network coverage but the terminal device 130 is outside the network coverage.

The technical solutions according to the embodiments of the present disclosure may be applied to various communication systems, such as: a global system of mobile communication (GSM) system, a code division multiple access (CDMA) system, a wideband code division multiple access (WCDMA) system, a general packet radio service (GPRS) system, a long term evolution (LTE) system, a LTE frequency division duplex (FDD) system, an LTE time division duplex (TDD) system, an advanced long term evolution (LTE-A) system, a universal mobile telecommunication system (UMTS), a worldwide interoperability for microwave access (WiMAX) communication system, a 5G mobile communication system, a new radio (NR) system, an evolved system of the NR system, an LTE-based access to unlicensed spectrum (LTE-U) system, an NR-based access to unlicensed spectrum (NR-U) system, a terrestrial network (TN) system, a non-terrestrial network (NTN) system, a wireless local area network (WLAN) system, a wireless fidelity (Wi-Fi) system, a cellular Internet of things system, a cellular passive Internet of things system, and may also be applied to the subsequent evolution systems of 5G NR system, and may also be applied to B5G, 6G, and subsequent evolution systems. In some embodiments of the present disclosure, “NR” may also be referred to as 5G NR system or 5G system. Among them, the 5G mobile communication system may include non-standalone (NSA) and/or standalone (SA).

The technical solutions provided by the embodiments of the present disclosure may also be applied to a machine type communication (MTC), a long term evolution-machine (LTE-M), a device to device (D2D) network, a machine to machine (M2M) network, an Internet of things (IoT) network, or other networks. The IoT network may include an Internet of vehicles. The communication methods in the Internet of vehicles system are collectively referred to as vehicle to X (V2X, X may represent anything). For example, the V2X may include: vehicle-to-vehicle (V2V) communications, vehicle-to-infrastructure (V2I) communications, vehicle-to-pedestrian (V2P) communications, vehicle-to-network (V2N) communications, or the like.

### 1) Timing Advance (TA)

In a current NR standard (including 3GPP Rel.17), a UE may be configured with up to 4 timing advance groups (TAGs) in one cell group (CG). Generally, one CG may have a plurality of serving cells, and each of the plurality of serving cells may be assigned a TAG identifier (ID).

The calculation formula for the timing advance for a terminal device (such as UE) is very simple, as illustrated hereinafter. The timing advance for the UE is based on a first symbol of a downlink channel or a slot where the channel is located as a downlink reference, and then the transmission is advanced:

$$( {N}_{TA} + {N}_{TA , offset} ) * {T}_{C}$$

In one CG, each serving cell may be pre-configured with a timing advance offset (TA offset) n-TimingAdvanceOffset, that is, N_{TA,offset} in the formula. The TA adjustment amount (N_{TA}) is based on a pre-configured offset. T_{C} is the minimum time unit in the NR system, T_{C}=1/(4096*480 kHz). N_{TA} may be provided by a medium access control (MAC) control element (CE) of the NW in a differential adjustment manner, that is, the current TA adjustment (new) is adjusted forward or backward in time based on the previous (old) TA, and the calculation formula is as follows:

$${N}_{( T A n e w )} = {N}_{( TAold )} + ( {T}_{A} - 31 ) * 16 * 64 / {2}^{μ}$$

The differential adjustment format of the TA of MAC CE is as illustrated in FIG. 2, that is, the TA is adjusted by T_{A} minimum time units based on a previous TA, and the granularity of the TA adjustment is TAG.

The field meanings involved in FIG. 2 are as follows.
(1) TAG identifier (TAG ID): This field indicates the TAG identifier of an addressed TAG; A TAG containing the SpCell has a TAG identifier 0; and a length of the field is 2 bits.
(2) Timing advance command: This field indicates an index value TA (0, 1, 2 . . . 63) used to control the amount of TA adjustment that the MAC entity has to apply (as specified in TS 38.213 6); and a length of the field is 6 bits.

The second type of TA adjustment method is the adjustment of an absolute value of TA, that is, there is no need to consider a previous TA value. The NW directly gives an absolute value N_{TA} over an absolute MAC CE or a random access response (RAR) MAC payload, and a value range of the N_{TA} is 0 to 3846, and an adjustment range of TA is N_{TA}=T_{A}*16*64*2^{μ}. These two types of TA acquisition methods occur during a random access process, and the acquired TA is applicable to a TAG corresponding to a target cell of the random access, so there is no need to include the TAG ID. For example, the absolute MAC CE is used for the two-step random access process, and the two-step random access is initiated to the SpCell, and therefore the MAC CE is applicable to a primary timing advance group (PTAG) corresponding to the MAC entity. That is, the definition of the PTAG is to include the SpCell. The format of the absolute MAC CE is as illustrated in FIG. 3.

The field meanings involved in FIG. 3 are as follows.
(1) Timing advance command: This field indicates an index value TA used to control the amount of TA adjustment that the MAC entity has to apply in TS 38.213 6; and the size of the field is 12 bits.
(2) R: Reserved bit, set to “0”.

The format of the MAC RAR involved in the above-mentioned scheme of the present disclosure may be as illustrated in FIG. 4.

### 2) Handover

Similar to the LTE system, the NR system supports the handover process of UEs in the connected state. In a case where a user using network services moves from one cell to another, or due to reasons such as wireless transmission service load adjustment, activation operation maintenance, equipment failure, or the like, to ensure the continuity of communication and the quality of service, the system needs to transfer the communication link of the user from the original cell to the new cell, that is, to perform the handover process.

Taking an Xn interface handover process as an example, the entire handover process is divided into the following three phases.
(1) Handover preparation: including measurement control and reporting, handover request, and confirmation. A handover command generated by a target cell is included in a handover confirmation message, and a source cell is not allowed to make any modifications to the handover command generated by the target cell and directly forwards the handover command to the UE.
(2) Handover execution: the UE immediately executes the handover process in response to receiving the handover command, that is, the UE disconnects from the source cell and connects to the target cell (such as performing the random access process, transmitting a RRC handover completion message to a target base station, or the like); a secondary node (SN) state transfer, and data forwarding.
(3) Handover completion: the target cell performs a path switch with an access and mobility management function (AMF) and a user port function (UPF), and releases the UE context of a source base station.

### 3) L1/L2 Triggered Mobility (LTM)

To reduce a delay caused by the handover, NR R18 supports the handover triggered by L1/L2, which is mainly for intra-centralized unit (intra-CU) handover scenarios. In a case where the CU (Packet Data Convergence Protocol (PDCP) unit/key) remains unchanged, the handover is performed based on layer 1 or layer 2 signaling.

The main process of LTM includes the following contents.
(1) The network side pre-configures a plurality of candidate cells for the terminal.
(2) The terminal performs L1 measurement and reporting on the configured candidate cells.
(3) The network side determines the target cell based on the measurement report and indicates the target cell to the terminal in the handover command. In some embodiments, the terminal may also perform downlink/uplink synchronization in advance prior to receiving the handover command.

In a related art, new radio (NR) supports cell handover triggered by L1/L2, wherein the terminal device may be configured with a plurality of candidate cells for cell handover; and during cell handover, the terminal device needs to perform uplink and downlink synchronization with a target cell in the plurality of candidate cells.

In traditional handover, the UE performs a random access process to achieve uplink synchronization upon receipt of the handover command. With respect to the contention-based random access process, the handover interruption time may be longer due to the conflict of random access resources.

The introduction of LTM is to reduce the interruption time of handover. To reduce the delay caused by the uplink synchronization process, one possible way for the UE is to acquire and maintain the TA of the candidate cell in advance, such that upon receipt of the handover command, the UE may reduce the delay of the random access process triggered for the uplink synchronization.

The existing TA maintenance is based on the TAG method. The UE also needs to maintain the TA of the source serving cell before handover, and therefore how to coexist the TA maintenance of the candidate cell with the TA maintenance of the source serving cell is the problem to be solved in the present disclosure.

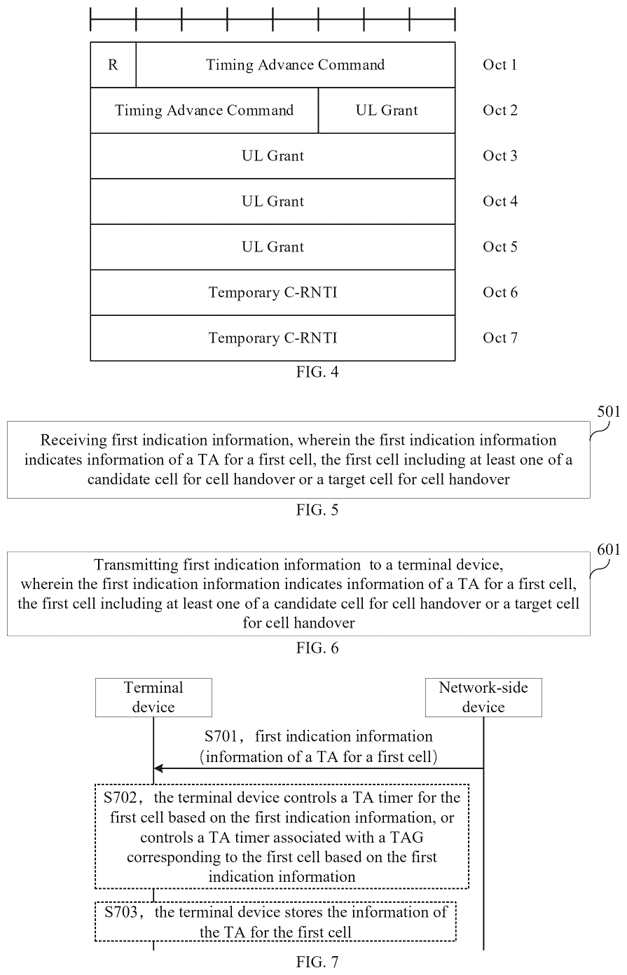

FIG. 5 illustrates a flowchart of a method for indicating timing advances according to some embodiments of the present disclosure. The method is applicable to a terminal device, wherein the terminal device may be the terminal device 120 or the terminal device 130 in the network architecture illustrated in FIG. 1. The method may include the following process.

In 501, first indication information is received, wherein the first indication information indicates information of a TA for a first cell, the first cell including at least one of a candidate cell for cell handover or a target cell for cell handover.

In summary, in the scheme illustrated in the embodiment of the present disclosure, the terminal device may receive the first indication information from the network device to acquire the information of the TA for at least one of the candidate cell or the target cell for cell handover in the terminal device, such that the information of the TA for the cell to be switched to or possibly switched to may be acquired before the handover, thereby saving the process of uplink and downlink synchronization in the subsequent handover process, reducing handover delay, and improving handover efficiency.

FIG. 6 illustrates a flowchart of a method for indicating timing advances according to some embodiments of the present disclosure. The method is applicable to a network device, wherein the network device may be the network device 110 in the network architecture illustrated in FIG. 1. The method may include the following process.

In 601, first indication information is transmitted to a terminal device, wherein the first indication information indicates information of a TA for a first cell, the first cell including at least one of a candidate cell for cell handover or a target cell for cell handover.

In summary, in the scheme illustrated in the embodiment of the present disclosure, the network device transmits the first indication information to the terminal device, such that the terminal device acquires the information of the TA for at least one of the candidate cell or the target cell for cell handover, such that the information of the TA for the cell to be switched to or possibly switched to is acquired before the handover, thereby saving the process of uplink and downlink synchronization in the subsequent handover process, reducing handover delay, and improving handover efficiency.

FIG. 7 illustrates a flowchart of a method for indicating timing advances according to some embodiments of the present disclosure. The method may be practiced based on the interactions between a terminal device and a network device; wherein the terminal device and the network device may be the network device 110, the terminal device 120 (or the terminal device 130) in the network architecture illustrated in FIG. 1. As illustrated in FIG. 7, the method may include the following processes.

In 701, the network device transmits first indication information to the terminal device; correspondingly, the terminal device receives the first indication information from the network device. The first indication information indicates information of a TA for a first cell, wherein the first cell includes at least one of a candidate cell for cell handover or a target cell for cell handover.

In some embodiments, the first indication information includes at least one of a TA adjustment value, a TA absolute value, an identifier of a TAG (TAG ID), an identifier of the target cell, or an identifier of the candidate cell.

In some embodiments, in a case where the first indication information carries at least one of the identifier of the target cell or the identifier of the candidate cell, the first cell may include the cell corresponding to at least one of the identifier of the target cell or the identifier of the candidate cell carried in the first indication information, or the first cell may include the cell corresponding to at least one of the identifier of the target cell or the identifier of the candidate cell carried in the first indication information, and an existing candidate cell of the terminal device.

In some embodiments, in a case where the first indication information does not carry at least one of the identifier of the target cell or the identifier of the candidate cell, the first cell may include at least one of an existing candidate cell or an existing target cell of the terminal device.

The first indication information may be indication information based on the TAG, or indication information based on a TA of a cell.

For example, in a case where the first indication information is the indication information based on the TAG, the first indication information may include at least one of the TA adjustment value, the TA absolute value, the identifier of the TAG, the identifier of the target cell, or the identifier of the candidate cell.

In a case where the first indication information is the indication information based on the TA of the cell, the first indication information may include at least one of the TA adjustment value, the TA absolute value, the identifier of the target cell, or the identifier of the candidate cell.

In some embodiments, the first indication information is carried by a timing advance command (TAC) MAC CE, an absolute TAC MAC CE, a new MAC CE, a MAC CE carrying handover information, an RAR carrying handover information, or a MsgB carrying handover information.

In some embodiments, the transmission of the first indication information may reuse an existing TAC MAC CE or an existing absolute TAC MAC CE used for transmitting information of a TA for a source cell.

In some embodiments, the first indication information may also be transmitted over the new MAC CE different from the above TAC MAC CE or the absolute TAC MAC CE.

In some embodiments, the first indication information may also be transmitted over the MAC CE carrying the handover information, the RAR carrying the handover information, or the MsgB carrying the handover information.

In some embodiments, the information of the TA for the candidate cell is determined by the network device; or the information of the TA for the candidate cell is determined by the terminal device during measurement; or the information of the TA for the candidate cell is determined by the terminal device during random access.

In some embodiments, the acquisition of the TA of the candidate cell may depend on the network side, for example, the network device determines the TA based on deployment information or determines TA of the UE based on timing difference measured by the UE. In this case, the network device may carry the TA information in a cell switch command or inform the UE of the information of the TA for the candidate cell before the handover.

In some embodiments, the acquisition of the TA of the candidate cell may be achieved based on UE measurement or random access channel (RACH).

For example, in a case where the UE acquires the TA based on the RACH, the UE may autonomously trigger the RACH, or trigger the RACH based on network indication. The RACH triggered by the network indication includes contention based random access (CBRA) and/or contention free random access (CFRA). With respect to the CFRA, a physical downlink control channel (PDCCH) order transmitted by the network device may indicate the identifier of the candidate cell, or the network device may carry a CFRA resource indication over a MAC CE, including identifier of the candidate cell, a synchronization signal/physical broadcast channel (SSB) index, a preamble index, or the like. In some embodiments, the network may indicate the identifier of the candidate cell in the RAR.

In some embodiments, in a case where the candidate cell is the current serving cell and the serving cell is in an inactive state, upon receipt of an indication to initiate RACH to the serving cell, the UE performs operations (behaviors) of: considering the deactivated serving cell as entering the active state, supporting all functions of an active state serving cell, and after the random access is successfully completed, considering the serving cell as entering the inactive state or continuing to remain in the active state.

Before the random access is successfully completed, the UE is supported to transmit RACH/physical uplink shared channel (PUSCH)/physical downlink shared channel (PUCCH) to the inactive state cell, and/or monitor the PDCCH of the inactive state cell.

In some embodiments, in a case where the candidate cell is the current serving cell and the serving cell is in a dormant state, upon receipt of an indication to initiate RACH to the serving cell, the UE performs operations (behaviors) of: considering the serving cell as transiting from the dormant state to the non-dormant state, and upon completion of the random access, considering the serving cell as returning to the dormant state or continuing to remain in the non-dormant state; and in a case where a current bandwidth part (BWP) is a dormant BWP, switching to another non-dormant BWP based on network indication or pre-configuration.

In some embodiments, the acquisition of the TA of the candidate cell may be based on UE measurement.

Upon receipt of the first indication information, the terminal device may perform the following process 702 or process 703.

In 702, the terminal device controls a TA timer for the first cell based on the first indication information, or controls a TA timer associated with a TAG corresponding to the first cell based on the first indication information.

In the embodiments of the present disclosure, the terminal device may control the TA timer for at least one of the candidate cell or the target cell for cell handover based on the first indication information, or control the TA timer associated with the TAG corresponding to at least one of the candidate cell or the target cell for cell handover.

In some embodiments, the control of the TA timer includes restarting the TA timer, starting the TA timer, or the like.

In some embodiments, upon receipt of the first indication information, the terminal device may immediately control the TA timer for the first cell based on the first indication information, or control the TA timer associated with the TAG corresponding to the first cell based on the first indication information.

In some embodiments, the process of controlling the TA timer for the first cell based on the first indication information, or controlling the TA timer associated with the TAG corresponding to the first cell based on the first indication information may include: in a case where a handover command has been received, controlling the TA timer for the first cell based on the first indication information, or controlling the TA timer associated with the TAG corresponding to the first cell based on the first indication information.

Upon receipt of the first indication information, the terminal device may first determine whether the handover command has been received. In a case where the handover command has been received, the process of controlling the TA timer for the first cell based on the first indication information, or controlling the TA timer associated with the TAG corresponding to the first cell based on the first indication information may be performed.

In some embodiments, the first indication information is based on TAG indication information; controlling the TA timer associated with the TAG corresponding to the first cell based on the first indication information includes: starting or restarting the TA timer associated with the TAG corresponding to the first cell.

In a case where the first indication information is the indication information based on the TAG, when the terminal device controls the TA timer associated with the TAG corresponding to the first cell, the terminal device may start or restart the TA timer associated with the TAG corresponding to the first cell.

For example, in a case where the first indication information is the indication information based on the TAG, when the TA timer associated with the TAG corresponding to the first cell is not started, the TA timer associated with the TAG corresponding to the first cell is started; and when the TA timer associated with the TAG corresponding to the first cell is started, the TA timer associated with the TAG corresponding to the first cell is restarted.

In some embodiments, the first indication information is indication information based on the TA of the cell; and controlling the TA timer for the first cell based on the first indication information includes: starting or restarting the TA timer associated with the first cell.

In a case where the first indication information is the indication information based on the TA of the cell, when the terminal device controls the TA timer for the first cell based on the first indication information, the terminal device may start or restart the TA timer associated with the first cell.

For example, in a case where the first indication information is the indication information based on the TA of the cell, when the TA timer associated with the first cell is not started, the TA timer associated with the first cell is started; and when the TA timer associated with the first cell is started, the TA timer associated with the first cell is restarted.

In 703, the terminal device stores the information of the TA for the first cell.

In some embodiments, upon receipt of the first indication information, the terminal device may temporarily store the information of the TA for the first cell indicated by the first indication information.

In some embodiments, storing the information of the TA for the first cell includes: storing the information of the TA for the first cell in a case where no handover command has been received.

For example, upon receipt of the first indication information is, the terminal device may determine whether the handover command has been received. In a case where the handover command has not been received, the terminal device may temporarily store the information of the TA for the first cell indicated by the first indication information for use upon receipt of the handover command later.

In some embodiments, the handover command is a message carrying handover information; and/or the handover command is a message that triggers a cell handover behavior.

The handover command may include a message carrying handover information that does not trigger cell handover.

In some embodiments, the handover information includes at least one of: an identifier of the target cell, TA information, BWP information, a PDCP data recovery indication, a radio link control (RLC) reestablishment indication, a MAC reset indication, transmission configuration index (TCI) information, or a cell-radio network temporary identifier (C-RNTI).

In some embodiments, the handover command may include a message that triggers the terminal device to execute cell handover.

In some embodiments, the message that triggers the cell handover behavior includes a TCI state.

In some embodiments, the handover command includes at least one of a MAC CE or downlink control information (DCI).

The handover command may be transmitted to the terminal device by the network device over the MAC CE and/or the DCI.

In some embodiments, the method according to the embodiments of the present disclosure further includes: in a case where the first indication information is the indication information based on the TAG and the handover command is received, the terminal device performs at least one of: continue running or restart a TA timer associated with a TAG for the target cell, and apply a TA value for the target cell to the TAG associated with the target cell; or
stop running other TA timers.

In some embodiments, in a case where the first indication information is the indication information based on the TAG, if the handover command is received, the terminal device may continue running or restart a TA timer associated with a TAG for the target cell, and apply a TA value for the target cell to the TAG associated with the target cell; and/or, the terminal device may stop running other TA timers. The other TA timers refer to TA timers other than the TA timer associated with the TAG for the target cell.

In some embodiments, the method according to the embodiments of the present disclosure further includes: in a case where the first indication information is the indication information based on the TA of the cell and the handover command is received, the terminal device performs at least one of:
start or restart the TA timer associated with the target cell;
associate the TA value for the target cell with the TAG associated with the target cell, and start or restart the TA timer associated with the TAG;
apply the TA value for the target cell to the TAG associated with the target cell; or
stop running other TA timers.

In some embodiments, in a case where the first indication information is the indication information based on the TA of the cell, upon receipt of the handover command, the terminal device may start or restart the TA timer associated with the target cell; in addition, the terminal device may also stop running other timers other than the TA timer for the target cell.

In some embodiments, in a case where the first indication information is the indication information based on the TA for the cell, upon receipt of the handover command, the terminal device may associate the TA value for the target cell with the TAG associated with the target cell, start or restart the TA timer associated with the TAG, and apply the TA value for the target cell to the TAG associated with the target cell; in addition, the terminal device may also stop running other timers other than the TA timer associated with the TAG corresponding to the target cell.

In some embodiments, the method according to the embodiments of the present disclosure further includes: the terminal device receives second indication information; and the terminal device continues running or restarts the TA timer associated with the TAG for the target cell, starts or restarts the TA timer associated with the target cell, and/or stops running other TA timers based on the second indication information.

That is, whether the terminal device continues running or restarts the TA timer associated with the TAG for the target cell, starts/restarts the TA timer associated with the target cell, and/or stops running other TA timers upon receipt of the handover command is indicated by the network device over the second indication information.

In some embodiments, the second indication information is network indication information or high-level indication information.

In addition, whether the terminal device continues running or restarts the TA timer associated with the TAG for the target cell, starts/restarts the TA timer associated with the target cell, and/or stops running other TA timers upon receipt of the handover command may be specified by the protocol.

In some embodiments, the method according to the embodiments of the present disclosure further includes: performing at least one of in a case where the handover command has been received:
stop running other TA timers;
perform uplink and downlink transmissions with the target cell;
monitor the PDCCH of the target cell;
clear a hybrid automatic repeat request (HARQ) buffer of a source serving cell;
clear the HARQ buffers of all serving cells;
clear the buffer of the HARQ process that fails to be continuously transmitted in the target cell;
release a resource of the source serving cell;
release resources of other source serving cells except the target cell;
retain a TA adjustment amount of the TAG associated with the target cell; and
in a case where a target primary cell in the target cell is a source secondary cell, and a target secondary cell in the target cell and the source secondary cell do not belong to the same TAG, perform conversion between a PTAG and a secondary timing advance group (STAG);
in a case where the target secondary cell is the source primary cell, and the target cell and the source primary cell do not belong to the same TAG, perform the conversion between the PTAG and the STAG; or
in a case where the target primary cell or the target secondary cell belongs to the same TAG as the source primary cell or the source secondary cell, not perform the conversion between the PTAG and the STAG.

In some embodiments, in a case where the target secondary cell in the target cell contains at least one secondary cell, the method according to the embodiments of the present disclosure further includes: managing an active state of the target secondary cell by one of:
reusing a state of the target secondary cell on a source side;
setting all target secondary cells to an active state or an inactive state according to protocol specifications;
setting an active state or an inactive state of each target secondary cell based on an explicit indication of the handover command;
determining an active state or an inactive state of the target secondary cell based on secondary cell activation/deactivation indication information in a configuration of the candidate cell; or
determining an active state or an inactive state of the target secondary cell based on validity of the TA/TAG associated with the target secondary cell.

In summary, in the scheme illustrated in the embodiments of the present disclosure, the network device may transmit the first indication information to the terminal device, such that the terminal device acquires the information of the TA for at least one of the candidate cell or the target cell for cell handover. In this way, the information of the TA for the cell to be switched to or possibly switched to may be acquired before the handover, thereby saving the process of uplink and downlink synchronization in the subsequent handover process, reducing handover delay, and improving handover efficiency.

In some embodiments, for the scenario of TA indication and maintenance based on TAG, the UE's processing may be as follows.

The UE receives the TA indication information from the network side, wherein the TA indication information may be carried in an existing TAC MAC CE, an existing absolute TAC MAC CE, a new MAC CE, or a MAC CE carrying handover information, an RAR carrying handover information, or a MsgB carrying handover information. The TA indication information includes at least one of the following:
1) a TA adjustment value;
2) a TA absolute value;
3) a TAG ID;
4) an identifier of the target cell; or
5) an identifier of the candidate cell.

TA maintenance may be achieved using a TA timer. For example, in a case where the TA indication information is received, the UE starts/restarts the TA timer associated with the TAG corresponding to the candidate cell. That is, in a case where the TA timer associated with the TAG of the candidate cell is running, the UE considers the TA of the candidate cell as valid. In some embodiments, the UE may choose to only store the TA information upon receipt of the TA indication information without starting the corresponding timer. For example, in a case where the UE receives the TA indication information before the handover command is received, the UE may choose to only store the TA without maintaining the TA, that is, the TA timer is not started.

The handover command may refer to a message carrying handover information (such as the identifier of the target cell, the TA information, the BWP information, the PDCP data recovery indication, the RLC reestablishment indication, the MAC reset indication, the TCI information, or the C-RNTI), or the handover command may be a message that actually triggers the handover (such as including the TCI state). The handover command may be the MAC CE and/or the DCI.

In a case where the UE receives the handover command, where the TA timer associated with the TAG of the candidate cell is running or the TA of the candidate cell is known, the behavior of the UE includes at least one of:
1) Continue running or restart the TA timer associated with the TAG for the target cell (candidate cell), and apply the TA value for the target cell to the TAG associated with the target cell, wherein the target cell may be at least one of a PCell, a PSCell, or a Scell.
2) Stop running other TA timers.

Based on 1) and 2), for example, in a case where the identifier of the TAG is common and unique between the source serving cell and the target cell, such as the identifiers of the TAG being 0-7, upon receipt of the TA value for one of the candidate/target cells before the handover command, such as the TA associated with a TAG 3, the UE may determine whether the TAG 3 is maintained on the serving cell side. For example, in a case where one of the SCells of the current source serving cell is also associated with the TAG 3, then when the UE receives the TA indication of the candidate cell (the TAG 3), the UE may restart the TA timer associated with this TAG.

Conversely, in a case where the source serving cell is only associated with a TAG 1 and a TAG 2, the UE may start the TAG 3 timer or choose not to start the TA timer, but only to store the TA value.

Furthermore, the decision of the UE to stop the TA timers associated with a plurality of TAGs of the source serving cell may also be based on whether the target cell has a same associated TAG.

Additionally, in a case where the identifier of the TAG is not common between the source serving cell and the target cell, for example, the identifiers of the TAG of the source serving cell are 0-3, and the identifiers of the TAG of the candidate cell are also 0-3, and the identifiers of the TAG of the source serving cell and the identifiers of the TAG of the candidate cell are maintained independently and not common, then upon receipt of the information of the TA for the candidate/target cell, the UE may choose to only maintain the TA without maintaining the TA timer; or the UE may start a TA timer for a non-TAG.

In some embodiments, the TA value may be an adjustment value or an absolute value. For example, for a TAG being maintained by the source serving cell, the network may indicate an adjustment value; and in a case where the TAG is not maintained by the source serving cell, the network may indicate a TA absolute value.
3) Perform uplink and downlink transmissions with the target cell.
4) Monitor the PDCCH of the target cell.
5) Clear the HARQ buffer of the source serving cell (at least one of the PCell, or the PSCell, or the SCell).
6) Clear the HARQ buffer of all serving cells (PCell, PSCell, and SCell).
7) Clear the buffer of the HARQ process that fails to be continuously transmitted in the target cell, which may be based on autonomous determination of the UE or network explicit indication, such as the HARQ process associated with the source serving cell that is not the target cell
8) Release the resources of the source serving cell (at least one of the PCell, or the PSCell, or the SCell), including a configured grant (CG), a sounding reference signal (SRS), semi-persistent scheduling (SPS), a PUSCH, a PUCCH, and the like.
9) Release the resources of the source serving cells that are not the target cell, including the CG, the SRS, the SPS, the PUSCH, the PUCCH, and the like.

Specifically, in a case where the current SCell is the target PCell, the configuration or resources of this SCell may not be released.
10) Retain the NTA of the TAG.

In addition, in a case where the target cell is the source serving cell before the handover command is received, the control process of conversion between a PTAG and an STAG may also be performed, wherein the target cell and the source serving cell may specifically include PCell/PSCell/SCell (including the active state or the inactive state).

Specifically, in a case where the target PCell is the source SCell, and the target PCell and source PCell do not belong to the same TAG, the conversion between the PTAG and the STAG is performed.

In a case where the target Scell is the source PCell, and the target PCell and the source PCell do not belong to the same TAG, the conversion between the PTAG and the STAG is performed.

In a case where the target SCell/PCell and source PCell/SCell belong to the same TAG, the conversion between the PTAG and the STAG is not performed.

In some embodiments, the operation/stop/restart of the TA timer may be based on network indication, high-level indication, or protocol agreement.

In some embodiments, when the candidate cell receives the TA indication information before the handover command, whether to start or restart the TAG timer associated with the candidate cell is determined based on network indication; or the network pre-configures the UE to indicate whether to start or restart the TAG timer associated with the candidate cell upon receipt of the TA indication information of the candidate cell.

In some embodiments, in a case where the SCell of the target cell includes at least one SCell (pcell change without SCell change), the active/inactive state of the SCell may be determined by:
a) reusing the state of the SCell on the source side, for example, a SCell in the active state on the source side remains in the active state after the handover, and vice versa remains in the inactive state;
b) specifying in protocol specifications that all SCells are in the activated or inactive state.
c) Setting the active/inactive state of each SCell based on the explicit indication of the handover command;
d) determining the state based on the SCell activation/deactivation indication information in the configuration of the candidate cell; and
e) determining whether the TA/TAG associated with the SCell is valid, if the TA is valid, the SCell is determined to be in the active state, and otherwise, the SCell is in the inactive state.

The above TA indication and maintenance may be applied to the following cases.
1) The candidate cell is not the current serving cell.
2) The candidate cell is the current serving cell, which may specifically be PCell/PSCell/SCell (including the active state or the inactive state).

In the above embodiments, TA maintenance is per TAG, with the advantage of reusing the existing TAG method for maintaining TA. However, the existing identifiers of the TAG are limited to a maximum of 4. In a case where the network configures a large number of candidate cells, the existing number of TAGs may not be sufficient, and new identifiers of the TAG, such as expanding the existing 4 identifiers of the TAG to 8 need to be introduced, thereby ensuring that the identifiers of the TAG are unique between the source serving cell and candidate cells. In a case where the identifiers of the TAG are not expanded, one possible way is to correspond the identifiers of the TAG of the source serving cell with those of the candidate cells, for example, TAG 3 of the original serving cell corresponds to TAG 2 of a candidate cell in the candidate cell list as the same TAG.

In some embodiments, for the scenario of TA indication and maintenance based on cells, TA indication is performed for each cell. At this time, the processing on the UE may be as follows.

The UE receives the TA indication information from the network side, wherein the TA indication information may be carried in a new MAC CE, an RAR, or a MAC CE carrying handover information. The TA indication information includes at least one of:
1) a TA adjustment value;
2) a TA absolute value;
3) an identifier of the target cell; or
4) an identifier of the candidate cell.

TA maintenance may be achieved over the TA timer. For example, in a case where the TA indication information is received, the corresponding TA timer is started. That is, in a case where the TA timer associated with the candidate cell is running, the UE considers the TA of the candidate cell to be valid. In some embodiments, the UE may choose to only store the TA information upon receipt of the TA indication information without starting the corresponding timer.

Upon receipt of the handover command, the UE performs synchronization/interaction with the target cell based on the identifier of the target cell indicated by the handover command and the TA information (which may be carried in the handover command or acquired previously). Specifically, the UE's behavior includes at least one of:
1) start or restart the TA timer for the target cell;
2) associate the TA value for the target cell with the TAG associated with the target cell, and start the TAG-associated TA timer; wherein in some embodiments, in a case where the TAG has a running timer, the TA timer for the TAG is restarted;
3) apply the TA value for the target cell to the TAG associated with the target cell;
4) stop running other TA timers;
5) perform uplink and downlink transmissions with the target cell;
6) monitor the PDCCH of the target cell;
7) clear the HARQ buffer of the source serving cell (at least one of the PCell, the PSCell, or the SCell);
8) clear the HARQ buffers of all serving cells (the PCell, the PSCell, and the SCell);
9) clear the buffer of the HARQ process that fails to be continuously transmitted in the target cell, which may be based on autonomous determination of the UE or network explicit indication, such as the HARQ process associated with the source serving cell that is not the target cell;
10) release the resources of the source serving cell (at least one of the PCell, the PSCell, or the SCell), including the CG, the SRS, the SPS, the PUSCH, the PUCCH, and the like;
11) release the resources of the source serving cells that are not the target cell, including the CG, the SRS, the SPS, the PUSCH, the PUCCH, and the like; wherein in a case wherein the current SCell is the target PCell, the configuration or resources of the SCell may not be released; or
12) retain the NTA of the TAG.

In addition, in a case where the target cell is the source serving cell before the handover command is received, the control process of conversion between a PTAG and an STAG may also be performed, wherein the target cell and source serving cell may specifically include PCell/PSCell/SCell (including the active state or the inactive state).

Specifically, in a case where the target PCell is the source SCell, and the target PCell and the source PCell do not belong to the same TAG, the conversion between the PTAG and the STAG is performed.

In a case where the target SCell is the source PCell, and the target PCell and the source PCell do not belong to the same TAG, the conversion between the PTAG and the STAG is performed.

In a case where the target SCell/PCell and the source PCell/SCell belong to the same TAG, the conversion between the PTAG and the STAG is not performed.

In some embodiments, the operation/stop/restart of the TA timer may be based on network indication, high-level indication, or protocol agreement.

In some embodiments, when the candidate cell receives the TA indication information before the handover command, whether to start or restart the TAG timer associated with the candidate cell is determined based on network indication; or the network pre-configures the UE to indicate whether to start or restart the TAG timer associated with the candidate cell upon receipt of the TA indication information of the candidate cell.

In some embodiments, in a case where the SCell of the target cell includes at least one SCell (PCell change without SCell change), the active/inactive state of the SCell may be determined by:
a) reusing the state of the SCell on the source side, for example, an SCell in the active state on the source side remains in the active state after the handover, and vice versa remains in the inactive state;
b) specifying in protocol specifications that all SCells are in the activated or inactive state.
c) setting the active/inactive state of each SCell based on the explicit indication of the handover command;
d) determining the state based on the SCell activation/deactivation indication information in the configuration of the candidate cell; and
e) determining whether the TA/TAG associated with the SCell is valid; if the TA is valid, the SCell is determined to be in the active state, and otherwise, the SCell is in the inactive state.

The above TA indication and maintenance may be applied to the following cases:
1) The candidate cell is not the current serving cell.
2) The candidate cell is the current serving cell, which may specifically be PCell/PSCell/SCell (including the active state or the inactive state).

FIG. 8 illustrates a block diagram of an apparatus for indicating timing advances according to some embodiments of the present disclosure. The apparatus may be configured to perform all or part of the processes performed by the terminal device in the above method embodiments. As illustrated in FIG. 8, the apparatus may include a receiving module 801.

The receiving module 801 is configured to receive first indication information, wherein the first indication information indicates information of a TA for a first cell, the first cell including at least one of a candidate cell for cell handover or a target cell for cell handover.

In some embodiments, the apparatus further includes: a processing module, configured to control a TA timer for the first cell based on the first indication information, or control a TA timer associated with a TAG corresponding to the first cell based on the first indication information.

In some embodiments, the processing module is configured to, in a case where a handover command has been received, control the TA timer for the first cell based on the first indication information, or control the TA timer associated with the TAG corresponding to the first cell based on the first indication information.

In some embodiments, the apparatus further includes a storing module, configured to store the information of the TA for the first cell.

In some embodiments, the storing module is configured to store the information of the TA for the first cell in a case where no handover command has been received.

In some embodiments, the first indication information is indication information based on the TAG; and the processing module is configured to start or restart the TA timer associated with the TAG corresponding to the first cell.

In some embodiments, the processing module is further configured to perform at least one of the following operations in a case where the handover command has been received:
continue running or restart the TA timer associated with the TAG for the target cell, and apply a TA value for the target cell to the TAG associated with the target cell; or
stop running other TA timers.

In some embodiments, the first indication information is indication information based on the TA of a cell; the processing module is configured to start or restart the TA timer associated with the first cell.

In some embodiments, the processing module is further configured to perform at least one of the following operations in a case where the handover command has been received:
start or restart the TA timer associated with the target cell;
associate the TA value for the target cell with the TAG associated with the target cell, and start or restart the TA timer associated with the TAG;
apply the TA value for the target cell to the TAG associated with the target cell; or
stop running other TA timers.

In some embodiments, the apparatus further includes a control module, configured to perform at least one of the following operations in a case where the handover command has been received:
perform uplink and downlink transmissions with the target cell;
monitor a PDCCH of the target cell;
clear an HARQ buffer of the source serving cell;
clear HARQ buffers of all serving cells;
clear a buffer of the HARQ process that fails to be continuously transmitted in the target cell;
release a resource of the source serving cell;
release resources of other source serving cells except the target cell;
retain a TA adjustment amount of the TAG associated with the target cell;
in a case where a target primary cell in the target cell is a source secondary cell, and a target secondary cell in the target cell and the source secondary cell do not belong to the same TAG, perform conversion between a PTAG and an STAG;
in a case where the target secondary cell is the source primary cell, and the target cell and the source primary cell do not belong to the same TAG, perform the conversion between the PTAG and the STAG; or
in a case where the target primary cell or the target secondary cell belongs to the same TAG as the source primary cell or the source secondary cell, not perform the conversion between the PTAG and the STAG.

In some embodiments, in a case where the target secondary cell in the target cell contains at least one secondary cell, the apparatus further includes a managing module, configured to manage an active state of the target secondary cell using one of the following methods:
reusing a state of the target secondary cell on the source side;
setting all target secondary cells to an active state or an inactive state according to protocol specifications;
setting an active state or an inactive state of each target secondary cell based on explicit indication of the handover command;
determining an active state or an in active state of the target secondary cell based on the secondary cell activation/deactivation indication information in a configuration of the candidate cell;
determining an active state or an inactive state of the target secondary cell based on validity of the TA/TAG associated with the target secondary cell.

In some embodiments, the handover command is a message carrying handover information; and/or the handover command is a message that triggers a cell handover behavior.

In some embodiments, the handover information includes at least one of: an identifier of the target cell, TA information, BWP information, a PDCP data recovery indication, an RLC reestablishment indication, a MAC reset indication, TCI information, or a C-RNTI.

In some embodiments, the message that triggers the cell handover behavior includes a TCI state.

In some embodiments, the handover command includes at least one of a MAC CE or DCI.

In some embodiments, the first indication information includes at least one of: a TA adjustment value, a TA absolute value, an identifier of a TAG, an identifier of the target cell, or an identifier of the candidate cell.

In some embodiments, the first indication information is carried by a TAC MAC CE, an absolute TAC MAC CE, a new MAC CE, a MAC CE carrying handover information, an RAR carrying handover information, or a MsgB carrying handover information.

In some embodiments, the information of the TA for the candidate cell is determined by the network device; or the information of the TA for the candidate cell is determined by the terminal device during measurement; or the information of the TA for the candidate cell is determined by the terminal device during random access.

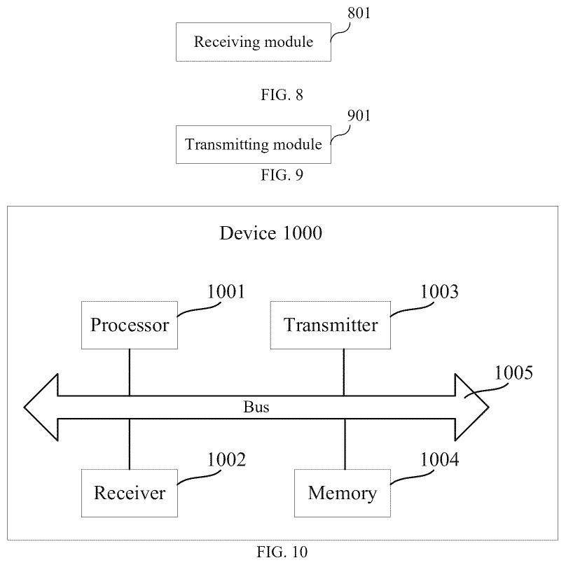

FIG. 9 illustrates a block diagram of an apparatus for indicating timing advances according to some embodiments of the present disclosure. The apparatus may be configured to perform all or part of the processes performed by the network device in the above method embodiments. As illustrated in FIG. 9, the apparatus may include a transmitting module 901.

The transmitting module 901 is configured to transmit first indication information to a terminal device, wherein the first indication information indicates Information of a TA for a first cell, the first cell including at least one of a candidate cell for cell handover or a target cell for cell handover.

In some embodiments, the first indication information includes at least one of: a TA adjustment value, a TA absolute value, an identifier of a TAG, an identifier of the target cell, or an identifier of the candidate cell.

In some embodiments, the first indication information is carried by a TAC MAC CE, an absolute TAC MAC CE, a new MAC CE, a MAC CE carrying handover information, an RAR carrying handover information, or a MsgB carrying handover information.

In some embodiments, the information of the TA for the candidate cell is determined by the network device; or the information of the TA for the candidate cell is determined by the terminal device during measurement; or the information of the TA for the candidate cell is determined by the terminal device during random access.

FIG. 10 illustrates a schematic diagram of a structure of a device 1000 according to some embodiments of the present disclosure. The device 1000 may include: a processor 1001, a receiver 1002, a transmitter 1003, a memory 1004, and a bus 1005.

The processor 1001 includes one or more processing cores, and the processor 1001 executes various functional applications and information processing by running software programs and modules.

The receiver 1002 and the transmitter 1003 may be implemented as one communication assembly, wherein the communication assembly may be a communication chip. This communication chip may also be referred to as a transceiver.

The memory 1004 is connected to the processor 1001 via the bus 1005.

The memory 1004 may be configured to store a computer program, and the processor 1001 is configured to run the computer program to perform the various processes performed by the terminal in the above method embodiments.

In addition, the memory 1004 may be implemented by any type of volatile or non-volatile storage device or a combination thereof, including but not limited to: a disk or optical disk, an electrically erasable programmable read-only memory, an erasable programmable read-only memory, a static random access memory, a read-only memory, a magnetic memory, a flash memory, or a programmable read-only memory.

The above device may be implemented as the terminal device or the network device in the above method embodiments.

In some embodiments, the device includes a processor, a memory, and a transceiver (the transceiver may include a receiver and a transmitter, the receiver receives information, and the transmitter transmits information).

In a case where the above device is implemented as the terminal device in the above method embodiments, the transceiver is configured to receive first indication information, wherein the first indication information indicates Information of a TA for a first cell, the first cell including at least one of a candidate cell for cell handover or a target cell for cell handover.

The processes performed by the transceiver and processor may refer to all or part of the processes performed by the terminal device in the embodiments illustrated in FIG. 5 or FIG. 7, which will not be repeated any further.

In a case where the above device is implemented as the network device in the above method embodiments, the transceiver is configured to transmit first indication information to a terminal device, wherein the first indication information indicates Information of a TA for a first cell, the first cell including at least one of a candidate cell for cell handover or a target cell for cell handover.

The processes performed by the transceiver and processor may refer to all or part of the processes performed by the network device in the embodiments illustrated in FIG. 6 or FIG. 7, which will not be repeated any further.

The embodiments of the present disclosure also provide a computer-readable storage medium, in which a computer program is stored, and the computer program is loaded and run by a processor to perform the various processes perform by the terminal device or network device in the method illustrated in FIG. 5, FIG. 6, or FIG. 7.

The present disclosure also provides a computer program product or computer program, which includes one or more computer instructions stored in a computer-readable storage medium. The processor of the terminal device or network device executes the one or more computer instructions, such that the terminal device or network device performs the various processes performed by the terminal device or network device in the method illustrated in FIG. 5, FIG. 6, or FIG. 7.

The present disclosure also provides a computer program, which includes one or more computer instructions stored in a computer-readable storage medium. The processor of the terminal device or network device executes the one or more computer instructions, such that the terminal device or network device performs the various processes performed by the terminal device or network device in the method illustrated in FIG. 5, FIG. 6, or FIG. 7.

The present disclosure also provides a chip, which is used in the terminal, and the chip may perform the various processes performed by the terminal device or network device in the method illustrated in FIG. 5, FIG. 6, or FIG. 7.

Those skilled in the art should be aware that in the above one or more examples, the functions described in the embodiments of the present disclosure may be implemented by hardware, software, firmware, or any combination thereof. When implemented by software, these functions may be stored on a computer-readable medium or transmitted as one or more instructions or codes on a computer-readable medium. A computer-readable medium includes a computer storage medium and a communication medium, wherein the communication medium includes any medium that facilitates the transfer of a computer program from one place to another. The storage medium may be any available medium that may be accessed by a general-purpose or special-purpose computer.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Described above are only embodiments of the present disclosure, which are not intended to limit the present disclosure. Any modifications, equivalent replacements, improvements, and the like, made within the spirit and principles of the present disclosure should be included within the protection scope of the present disclosure.

1. A method for indicating timing advances, applicable to a terminal device, the method comprising:
receiving first indication information, wherein the first indication information indicates information of a timing advance (TA) for a first cell, the first cell comprising at least one of a candidate cell for cell handover or a target cell for cell handover.

2. The method according to claim 1, further comprising:
controlling a TA timer for the first cell based on the first indication information, or controlling a TA timer associated with a TA group (TAG) corresponding to the first cell based on the first indication information.

3. The method according to claim 2, wherein controlling the TA timer for the first cell based on the first indication information, or controlling the TA timer associated with the TAG corresponding to the first cell based on the first indication information comprises:
in a case where a handover command has been received, controlling the TA timer for the first cell based on the first indication information, or controlling the TA timer associated with the TAG corresponding to the first cell based on the first indication information.

4. The method according to claim 1, further comprising:
storing the information of the TA for the first cell.

5. The method according to claim 4, wherein storing the information of the TA for the first cell comprises:
in a case where no handover command has been received, storing the information of the TA for the first cell.

6. The method according to claim 2, wherein:
the first indication information is based on indication information of the TAG; and
controlling the TA timer associated with the TAG corresponding to the first cell based on the first indication information comprises:
starting or restarting the TA timer associated with the TAG corresponding to the first cell.

7. The method according to claim 6, further comprising:
in a case where a handover command has been received, performing at least one of:
continue running or restarting a TA timer associated with a TAG for the target cell, and apply a TA value for the target cell to the TAG associated with the target cell; or
stop running other TA timers.

8. The method according to claim 2, wherein the first indication information is based on indication information of a TA for a cell;
controlling the TA timer for the first cell based on the first indication information comprises:
starting or restarting the TA timer associated with the first cell.

9. The method according to claim 8, further comprising:
in a case of having received a handover command, performing at least one of:
start or restart a TA timer associated with the target cell;
associate a TA value for the target cell with a TAG associated with the target cell, and start or restart a TA timer associated with the TAG;
apply a TA value for the target cell to a TAG associated with the target cell; or
stop running other TA timers.

10. The method according to claim 3, wherein:
the handover command is a message carrying handover information; and/or
the handover command is a message that triggers a cell handover behavior.

11. A terminal device, comprising:
a processor and a memory;
wherein the memory stores a computer program, which when executed by the processor, causes the terminal device to:
receive first indication information, the first indication information indicating information of a timing advance (TA) for a first cell, the first cell comprising at least one of a candidate cell for cell handover or a target cell for cell handover.

12. The terminal device according to claim 11, wherein the computer program, which when executed by the processor, further causes the terminal device to:
control a TA timer for the first cell based on the first indication information, or control a TA timer associated with a TA group (TAG) corresponding to the first cell based on the first indication information.

13. The terminal device according to claim 12, wherein the computer program, which when executed by the processor, further causes the terminal device to:
in a case where a handover command has been received, control the TA timer for the first cell based on the first indication information, or control the TA timer associated with the TAG corresponding to the first cell based on the first indication information.

14. The terminal device according to claim 11, wherein the first indication information comprises at least one of:
a TA adjustment value, a TA absolute value, an identifier of a TA group (TAG), an identifier of the target cell, or an identifier of the candidate cell.

15. The terminal device according to claim 11, wherein the first indication information is carried by a TA command (TAC) medium access control (MAC) control element (CE), an absolute TAC MAC CE, a new MAC CE, a MAC CE carrying handover information, a random access response (RAR) carrying handover information, or a MsgB carrying handover information.

16. The terminal device according to claim 11, wherein:
information of a TA for the candidate cell is determined by a network device; or
information of a TA for the candidate cell is determined by the terminal device during measurement; or
information of a TA for the candidate cell is determined by the terminal device during random access.

17. A network device, comprising:
a processor and a memory;
wherein the memory stores a computer program, which when executed by the processor, causes the network device to:
transmit first indication information to a terminal device, the first indication information indicating information of a timing advance (TA) for a first cell, the first cell comprising at least one of a candidate cell for cell handover or a target cell for cell handover.

18. The network device according to claim 17, wherein the first indication information comprises at least one of:
a TA adjustment value, a TA absolute value, an identifier of a TA group (TAG), an identifier of the target cell, or an identifier of the candidate cell.

19. The network device according to claim 17, wherein the first indication information is carried by a TA command (TAC) medium access control (MAC) control element (CE), an absolute TAC MAC CE, a new MAC CE, a MAC CE carrying handover information, a random access response (RAR) carrying handover information, or a MsgB carrying handover information.

20. The network device according to claim 17, wherein:
information of a TA for the candidate cell is determined by the network device; or
information of a TA for the candidate cell is determined by the terminal device during measurement; or
information of a TA for the candidate cell is determined by the terminal device during random access.
